(19) United States
(12) Patent Application Publication
(10) Pub. No.: US 2005/0268568 A1
(43) Pub. Date: Dec. 8, 2005

(54) Backflow prevention cap for panels having interlocking folds

(76) Inventor: Yee-Hyeng Kim, Gyeongsangbuk-do (KR)

Correspondence Address: BOOTH UDALL, PLC, 1423 S. HIGLEY ROAD, SUITE 110, MESA, AZ, 85206, US

(21) Appl. No.: 10/519,570

(22) PCT Filed: Jun. 21, 2004
(86) PCT No.: PCT/KR04/01490

§ 371 Date: Jul. 22, 2005

(30) Foreign Application Priority Data
Jun. 26, 2003 (KR) 20-2003-0020263

(51) Int. Cl. E06B 7/14

(52) U.S. Cl. 52/204.52; 52/209

(57) ABSTRACT

A backflow prevention cap for panels having interlocking-folds, which prevents a backflow of water into seamed panels through fine gaps between the interlocking folds of the seamed panels by wind action. Each of panels has a tetragonal panel body (7), outer interlocking folds (9) provided by folding outwardly two neighboring sides of the panel body, and inner interlocking folds, (11) provided by folding inwardly two remaining sides of the panel body. The backflow prevention cap includes a water shielding part (3) having a sheet-shaped wedge structure to be installed in the top ends of the outer interlocking folds (9) of each panel and supported in the top ends of the outer interlocking folds by a locking means when the panels are continuously seamed together through a fold-interlocking method.

### TECHNICAL FIELD

The present invention relates, in general, to backflow prevention caps for panels having interlocking folds and, more particularly, to a backflow prevention cap for panels having interlocking folds which prevents a backflow of water into seamed panels through fine gaps between the interlocking folds of the seamed panels by wind action.

### BACKGROUND ART

Generally, buildings are fabricated with columns, walls and roofs, which protect the interiors of the buildings from the outdoor environment and thereby provide comfortable indoor spaces to inhabitants. To accomplish the above-mentioned functions of the buildings, the roofs, and the indoor and outdoor wall surfaces must be constructed to have thermal-insulating and water-resistant structures. Furthermore, typically, the roofs and the indoor and outdoor wall surfaces of buildings are covered with decorative interior and exterior finishing materials to provide attractive appearances of the buildings, resulting in beautification of residential areas, towns and cities where the buildings are placed.

In the related art, a variety of stone panels and metal panels have been proposed as the interior and exterior finishing materials for buildings. Of the conventional interior and exterior finishing panels for buildings, the stone panels are problematic in that an installation thereof on a building must be accompanied by an additional sealing process to seal the joints of the panels, thus causing a difficulty during a process of installing the stone panels. Furthermore, the stone panels are heavy, so that workers suffer exhaustion and injury while handling the stone panels.

Thus, in place of the stone panels having the above-mentioned problems, metal panels have been preferably used in recent years. The metal panels as the interior and exterior finishing materials for buildings are purchased at low costs, quickly installed, and provide more beautiful appearances to buildings, in comparison with the stone panels. Thus, many consumers prefer the metal panels to the stone panels.

Most conventional metal panels, which have been proposed as the interior and exterior finishing materials for buildings, are constructed as types to be seamed together through a fold-interlocking manner. In a detailed description, each of the conventional metal panels to be seamed together through the fold-interlocking manner comprises a square, rectangular or rhombic panel body, of which two neighboring sides are folded outwardly to provide outer interlocking folds, and two remaining sides are folded inwardly to provide inner interlocking folds.

Thus, when installing a plurality of metal panels having the interlocking folds on a support surface, one of the two outer interlocking folds of a metal panel interlocks with one of the too inner interlocking folds of another metal panel, thus seaming the two metal panels together. The above-mentioned interlocking of the outer and inner interlocking folds is repeated to provide a fold-interlocking structure. Thus, the fold-interlocking metal panels provide a decorative roofing or a decorative wall covering.

In the above state, to fasten the fold-interlocking metal panels as the interior and exterior finishing materials for buildings to a roof or an indoor or outdoor wall surface, locking clips and locking nails must be used.

However, fine gaps unavoidably remain in the outer and inner interlocking folds of the seamed conventional metal panels used as the interior and exterior finishing materials of a building. Thus, the conventional metal panels are problematic in that water, dropping onto the seamed panels, may reverse-flow into the panels through the fine gaps between the interlocking folds of the seamed panels by wind action.

### DISCLOSURE OF INVENTION

### Technical Solution

Accordingly, the present invention has been made keeping in mind the above problems occurring in the prior art, and an object of the present invention is to provide a backflow prevention cap for panels having interlocking folds which prevents a backflow of water into seamed panels through fine gaps between the interlocking folds of the seamed panels by wind action.

In order to accomplish the above object, the present invention provides a backflow prevention cap for panels each having a tetragonal panel body; outer interlocking folds provided by folding outwardly too neighboring sides of the panel body to extend in parallel to a surface of the panel body; and inner interlocking folds provided by folding inwardly two remaining sides of the panel body opposite to the outer interlocking folds so that the inner interlocking folds extend in parallel to an opposite surface of the panel body, the backflow prevention cap comprising: a water shielding part having a sheet-shaped wedge structure to be installed in top ends of the outer interlocking folds of each of the panels and supported in the top ends of the outer interlocking folds by locking means when the panels are continuously seamed together by the outer and inner interlocking folds thereof that interlock with each other, the water shielding part thus preventing a backflow of water from the panel body of each of the seamed panels into gaps defined between the outer and inner interlocking folds of the seamed panels.

The water shielding part may comprise an L-shaped hollow body with two sidewalls, and a locking portion provided at a predetermined position of the L-shaped water shielding part to use a locking nail as the locking means.

The water shielding part may comprise a triangular solid body with a locking portion provided at a predetermined position of the triangular water shielding part to use a locking nail as the locking means.

The water shielding part may comprise an L-shaped hollow body with two sidewalls that is supported by an adhesive as the locking means.

The water shielding part may comprise a triangular solid body that is supported by an adhesive as the locking means.

Each of the panels having the outer and inner interlocking folds may be installed on a support surface by the locking nail used as the locking means or a separate locking clip.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view of a backflow prevention cap for panels having interlocking folds, according to a first embodiment of the present invention;

FIG. 2 is a perspective view showing an installation of the backflow prevention cap according to the first embodiment in a first panel having interlocking folds;

FIG. 3 is a perspective view of a backflow prevention cap for panels having interlocking folds, according to a second embodiment of the present invention;

FIG. 4 is a perspective view showing an installation of the backflow prevention cap according to the second embodiment in a first panel having interlocking folds;

FIG. 5 is a plan view showing a plurality of first panels having the interlocking folds, which are continuously seamed together through a fold-interlocking method, with a plurality of backflow prevention caps according to the first or second embodiment that are respectively installed in the panels;

FIG. 6 is a perspective view of a backflow prevention cap for panels having interlocking folds, according to a third embodiment of the present invention;

FIG. 7 is a perspective view showing an installation of the backflow prevention cap according to the third embodiment in a second panel having interlocking folds;

FIG. 8 is a perspective view of a back-flow prevention cap for panels having interlocking folds, according to a fourth embodiment of the present invention;

FIG. 9 is a perspective view showing an installation of the backflow prevention cap according to the fourth embodiment in a second panel having interlocking folds; and

FIG. 10 is a plan view showing a plurality of second panels having the interlocking folds, which are continuously seamed together through a fold-interlocking method, with a plurality of backflow prevention caps according to the third or fourth embodiment that are respectively installed in the panels.

### BEST MODE FOR CARRYING OUT THE INVENTION

Reference should now be made to the drawings, in which the same reference numerals are used throughout the different drawings to designate the same or similar components.

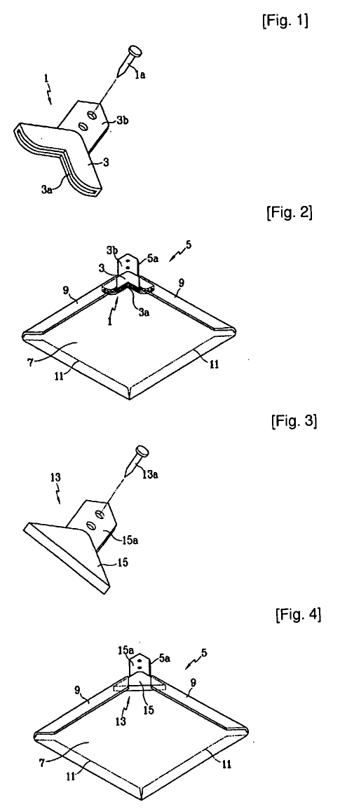

FIG. 1 is a perspective view of a backflow prevention cap for panels having interlocking folds, according to a first embodiment of the present invention. As shown in the drawing, the backflow prevention cap 1 according to the first embodiment includes a water shielding part 3.

The backflow prevention cap 1 according to the first embodiment may be used with a first panel 5 having interlocking folds. As shown in FIG. 2, the first panel 5 comprises a panel body 7 having a tetragonal sheet shape, with two outer interlocking folds 9 and two inner interlocking folds 11 which are provided on the panel body 7. Thus, a plurality of first panels 5 can be continuously seamed together through a fold-interlocking method.

In the first panel 5 having the interlocking folds, the panel body 7, which defines the shape of the panel 5, is preferably constructed to have a rhombic or square shape with four equal sides. However, it should be understood that the panel body 7 may be constructed in the form of a rectangular or parallelogramic shape, without affecting the functioning of the present invention. The outer interlocking folds 9 are formed by folding outwardly two neighboring sides of the tetragonal panel body 7 to extend in parallel to a surface of the panel body 7. In the meantime, the two inner interlocking folds 11 are formed by folding inwardly two remaining sides of the tetragonal panel body 7 which are opposite to the two outer interlocking folds 9, so that the two inner interlocking folds 11 extend in parallel to an opposite surface of the panel body 7.

As shown in FIG. 2, the backflow prevention cap 1 according to the first embodiment of the present invention is constructed so that the cap 1 is installed in the top ends of the outer interlocking folds 9 of the first panel 5. Thus, the backflow prevention cap 1 prevents a back-flow of water from the panel body 7 into seamed panels 5 through the gaps between the outer and inner interlocking folds 9 and 11 of the seamed panels 5.

In a detailed description, the backflow prevention cap 1 according to the first embodiment of the present invention has the water shielding part 3 that is installed in the top ends of the outer interlocking folds 9. In the above state, the cap 1 installed in the panel 5 is supported by a locking means. The water shielding part 3 of the backflow prevention cap 1 has a sheet-shaped wedge structure, so that the water shielding part 3 effectively stops and prevents the backflow of water into the seamed panels through the gaps between the interlocking folds of the seamed panels.

In the first embodiment, the water shielding part 3 comprises an L-shaped hollow body with too sidewalls defining a water guide slot 3a between them. A locking portion 3b is provided at a corner of the L-shaped water shielding part 3, so that the backflow prevention cap 1 is supported to a locking part 5a of the first panel 5 at the locking portion 3b thereof by means of a locking nail 1a as a locking means. In the above state, the locking portion 3b of the backflow prevention cap 1 is supported to the locking part 5 of the first panel 5 by the locking nail 1a while overlapping the locking part 5a. To use the first panel 5 with the backflow prevention cap 1 having the above-mentioned locking portion 3b according to the first embodiment, the locking part 5a of the first panel 5 corresponds to the locking portion 3b. Furthermore, the water shielding part 3 of the cap 1 according to the first embodiment is preferably constructed so that the two sidewalls of the water guide slot 3a are inclined to be opened toward both the panel body 7 and the outer interlocking folds 9. Thus, the backflow prevention efficiency of the water shielding part 3 is enhanced.

FIG. 3 is a perspective view of a backflow prevention cap 13 for panels having interlocking folds, according to a second embodiment of the present invention. In the second embodiment, the general construction and operation of the backflow prevention cap 13 remain the same as those of the backflow prevention cap 1 according to the first embodiment. Thus, the construction and operation of the backflow prevention cap 13 which are the same as those of the first embodiment are not described in the following description where only the specified construction and operation of the cap 13 different from those of the first embodiment will be comparatively described.

Different from the backflow prevention cap 1 according to the first embodiment in which the water shielding part 3 comprises the L-shaped hollow body with the two sidewalls defining the water guide slot 3a between them, a water shielding pail 15 of the backflow prevention cap 13 according to the second embodiment comprises a triangular solid body, with a locking portion 15a provided at a corner of the triangular water shielding part 15. To efficiently prevent a backflow of water from the panel body 7 into seamed panels through gaps between the interlocking folds of the seamed panels, the water shielding part 15 has a substantial thickness to allow the water shielding part 15 to be installed in the top ends of the outer interlocking folds 9 through a forcible fitting manner.

FIG. 4 is a perspective view showing an installation of the backflow prevention cap 13 according to the second embodiment in a first panel 5 having interlocking folds. When the backflow prevention cap 13 is installed in the panel 5, the cap 13 yields the same operational effect as that expected from the backflow prevention cap 1 according to the first embodiment that is installed in the first panel 5 as shown in FIG. 2.

FIG. 5 is a plan view showing a plurality of first panels 5, which have the interlocking folds and are continuously seamed together through a fold-interlocking method, with a plurality of backflow prevention caps 1, 13 according to the first or second embodiment that are respectively installed in the panels 5. To fasten the plurality of first panels 5 to a support surface, the first panels 5 are continuously seamed together at the outer and inner interlocking folds 9 and 11 thereof that interlock with each other. Thereafter, the locking nails 1a are driven to the locking portions 3b, 15a of the backflow prevention caps 1, 13 according to the first or second embodiment that overlap the locking parts 5a of the panels 5.

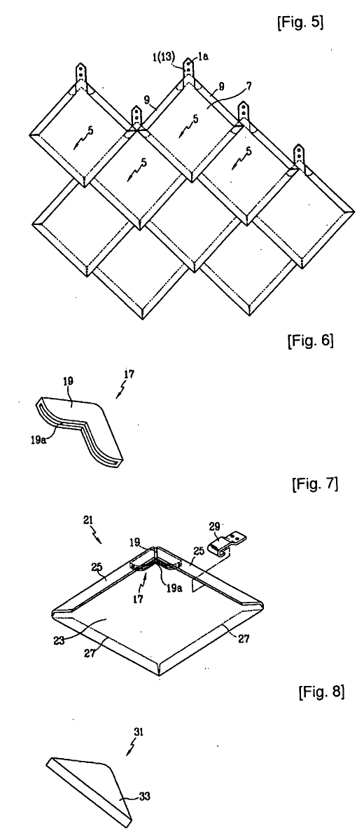

FIG. 6 is a perspective view of a backflow prevention cap 17 for panels having interlocking folds, according to a third embodiment of the present invention. As shown in the drawing, the water shielding part 19 of the backflow prevention cap 17 according to the third embodiment is altered as follows.

The backflow prevention cap 17 according to the third embodiment may be used with a second panel 21 having interlocking folds. As shown in FIG. 7, the second panel 21 comprises a panel body 23 having a tetragonal sheet shape, with two outer interlocking folds 25 and two inner interlocking folds 27 which are provided on the panel body 23. Thus, a plurality of second panels 21 can be continuously seamed together through a fold-interlocking method.

As described above, the general shape of the second panel 21 remains the same as that described for the first panel 5. However, the second panel 21 is fastened to a support surface by a separate locking clip 29 in place of the locking part 5a, different from the first panel 5.

As shown in FIG. 7, the backflow prevention cap 17 according to the third embodiment of the present invention is installed in the top ends of the outer interlocking folds 25. Thus, the backflow prevention cap 17 prevents a backflow of water from the panel body 23 into seamed panels 21 through the gaps between the outer and inner interlocking folds 25 and 27 of the seamed panels 21.

The backflow prevention cap 17 according to the third embodiment is supported in the top ends of the two outer interlocking folds 25 of the second panel 21 using an appropriate adhesive as a locking means. The water shielding part 19 of the backflow prevention cap 17 according to the third embodiment comprises an L-shaped hollow body with to sidewalls defining a water guide slot 19a between them, in the same manner as that described for the backflow prevention cap 1 according to the first embodiment. Furthermore, the water shielding part 19 of the cap 17 is preferably constructed so that the two sidewalls of the water guide slot 19a are inclined to be opened toward both the panel body 23 and the outer interlocking folds 25. Thus, the backflow prevention efficiency of the water shielding part 19 is enhanced.

FIG. 8 is a perspective view of a backflow prevention cap 31 for panels having interlocking folds, according to a fourth embodiment of the present invention. In the fourth embodiment, the general construction and operation of the backflow prevention cap 31 remain the same as those of the backflow prevention cap 17 according to the third embodiment. Thus, the construction and operation of the backflow prevention cap 31 which are the same as those of the third embodiment are not described in the following description where only the specified construction and operation of the cap 31 different from those of the third embodiment will be comparatively described.

Different from the backflow prevention cap 17 according to the third embodiment in which the water shielding part 19 comprises the L-shaped hollow body with the two sidewalls defining the water guide slot 19a between them, the water shielding part 33 of the backflow prevention cap 31 according to the fourth embodiment comprises a triangular solid body. To efficiently prevent a backflow of water from a panel body 23 into seamed panels through gaps between the interlocking folds of the seamed panels, the water shielding part 33 has a substantial thickness to allow the water shielding part 33 to be installed in the top ends of the outer interlocking folds 25 through a forcible fitting manner.

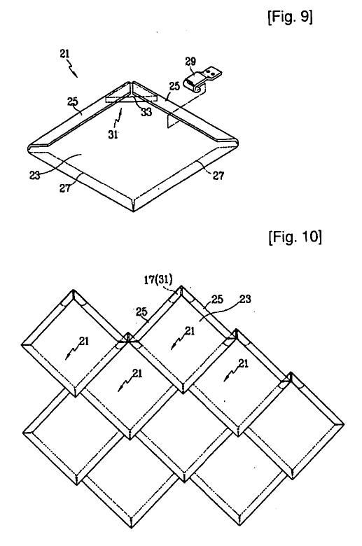

FIG. 9 is a perspective view showing an installation of the backflow prevention cap 31 according to the fourth embodiment in a second panel 21 having interlocking folds. When the backflow prevention cap 31 is installed in the second panel 21, the cap 31 yields the same operational effect as that expected from the backflow prevention cap 17 according to the third embodiment that is installed in the second panel 21 as shown in FIG. 7.

FIG. 10 is a plan view showing a plurality of second panels 21, which have the interlocking folds and are continuously seamed together through a fold-interlocking method, with a plurality of backflow prevention caps 17, 31 according to the third or fourth embodiment that are installed in the panels 21. To fasten the plurality of second panels 21 to a support surface, the second panels 21 are continuously seamed together at the outer and inner interlocking folds 25 and 27 thereof that interlock with each other. Thereafter, the second panels 21 are fastened to the support surface by the locking clips 29. In the above state, the backflow prevention caps 17, 31 according to the third or fourth embodiment are supported in each of the second panels 21 using an appropriate adhesive, thus preventing a backflow of water into the seamed panels 21 through fine gaps between the interlocking folds of the seamed panels by wind action.

### INDUSTRIAL APPLICABILITY

As described above, the present invention provides a backflow prevention cap for panels having interlocking folds. In the present invention, the backflow prevention cap which may have various-shaped water shielding parts is installed in the outer interlocking folds of a panel that may have various shapes. Thus, in comparison with a conventional technique of simply seaming the panels together through a fold-interlocking of the outer and inner interlocking folds without using any backflow prevention cap, the fold-interlocking method using the backflow prevention caps of the present invention prevents a backflow of water driven by wind into seamed panels through gaps between the inner and outer interlocking folds of the seamed panels.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A backflow prevention cap for panels each having a tetragonal panel body; outer interlocking folds provided by folding outwardly two neighboring sides of the panel body to extend in parallel to a surface of the panel body; and inner interlocking folds provided by folding inwardly two remaining sides of the panel body opposite to the outer interlocking folds so that the inner interlocking folds extend in parallel to an opposite surface of the panel body, the backflow prevention cap comprising:
a water shielding part having a sheet-shaped wedge structure to be installed in top ends of the outer interlocking folds of each of the panels and supported in the top ends of the outer interlocking folds by locking means when the panels are continuously seamed together by the outer and inner interlocking folds thereof that interlock with each other, the water shielding part thus preventing a backflow of water from the panel body of each of the seamed panels into gaps defined between the outer and inner interlocking folds of the seamed panels.

2. The backflow prevention cap according to claim 1, wherein the water shielding part comprises an L-shaped hollow body with two sidewalls, and a locking portion provided at a predetermined position of the L-shaped water shielding part to use a locking nail as the locking means.

3. The backflow prevention cap according to claim 1, wherein the water shielding part comprises a triangular solid body with a locking portion provided at a pre-determined position of the triangular water shielding part to use a locking nail as the locking means.

4. The backflow prevention cap according to claim 1, wherein the water shielding part comprises an L-shaped hollow body with two sidewalls, and is supported by an adhesive as the locking means.

5. The backflow prevention cap according to claim 1, wherein the water shielding part comprises a triangular solid body, and is supported by an adhesive as the locking means.

6. The backflow prevention cap according to any one of claims 1, 2, 3, 4 and 5, wherein each of the panels having the outer and inner interlocking folds is installed on a support surface by the locking nail used as the locking means or a separate locking clip.
